(19) United States
(12) Patent Application Publication
(10) Pub. No.: US 2011/0307940 A1
(43) Pub. Date: Dec. 15, 2011

(54) INTEGRATED WEB APPLICATION SECURITY FRAMEWORK

(76) Inventor: JOSEPH WONG, Vancouver (CA)

(21) Appl. No.: 12/796,680

(22) Filed: Jun. 9, 2010

(51) Int. Cl. H04L 9/32

(52) U.S. Cl. 726/4; 726/5

(57) ABSTRACT

Various embodiments of systems and methods for integrated web application security are described herein. A unified framework for authentication, authorization, and session management specifically separates credential gathering and authentication as two separate steps that may be extended independently. The credential gathering is done by specific credential providers, and the authentication is performed independently. In another aspect, login/logout processing is separated from the authentication logic. Session validators, credential providers, authenticators, authorizers may be run independently.

### FIELD

The field relates to web application security. More precisely, the field relates to a unified framework for authentication, authorization, and session management.

### BACKGROUND

Some web applications do not provide authentication and authorization out-of-the-box. A common suggested strategy for building authentication and authorization is to install a set of around filters that are executed before a Hypertext Transfer Protocol (HTTP) request is dispatched to the actual business logic. This allows the business logic to be protected by authentication and authorization checks.

Many web applications have users logging in and logging out of the application. Once a user logs in to the application using a set of valid credentials, the user remains authenticated until the user logs out of the application. A typical method of implementing logging in and logging out may be embodied in the following pseudo code:

### Login:

If the user's supplied credentials are valid then

Log the user in, including associating the user with the session

End if

### Logout:

Dissociate the user with the session.

The act of logging in may not be limited to the user using the web application user interface to enter his/her name and password. For example, it may be possible for a client application to log in for the user by providing username-password credentials via HTTP basic authentication. The client application may also use OAuth (an open protocol to allow secure application programming interface authorization in a simple or standard method from desktop and web applications), Security Assertion Markup Language (SAML) or some other Single Sign On (SSO) technology to log in for the user.

An HTTP request to an application system may carry information for the purpose of authentication and authorization. As such a system evolves, there is often the requirement to add support for new modes of authentication and new authorization checks. As the system grows in complexity and in the number of authentication and authorization schemes, it becomes harder to implement new schemes that are correct, and work well along with other existing schemes, without introducing new vulnerabilities.

Also, credentials such as username-password can be carried via multiple transport mechanisms, for example, HTTP basic authentication, HTTP request body, some form of an encrypted token and the like. For a given kind of credential, there is typically only one mechanism to validate the credentials and authenticate the user. With existing technologies, the credential gathering and the authentication mechanism are typically coupled, thus requiring each credential gatherer to be able to validate the credentials itself. This may lead to potential vulnerabilities as new modules are added that claim to operate on the same kind of credentials, (e.g., username-password), but differ in how they validate those credentials.

Similar difficulties are also present in session management. Depending on the circumstances, different steps need to be executed when the user logs in or logs out. With existing technologies, these steps are implemented in an ad-hoc fashion with the consequence that multiple pieces of such logic may not interact well. This may also introduce security vulnerabilities if, for example, the user identity changes but the code is still running with the old user's privileges.

### SUMMARY

Various embodiments of systems and methods for integrated web application security framework are described herein. In one embodiment, the method includes receiving an HTTP request and performing a session validation. The method also includes establishing and verifying a user identity and authorizing the user identity and a user action. The method further includes performing login/logout processing and associating rights to a user or the session.

In another embodiment, the system includes a browser configured to send an HTTP request to a web server and a set of modules associated with the web server. The system further includes a processor configured to execute the set of modules. The set of modules includes a session validator module configured to determine whether an existing session is invalidated; a credential provider module configured to provide credentials of a given kind, the credentials extracted from the HTTP request; an authenticator module configured to verify credentials provided by the credential provider module and to produce an authenticated user identity for a user; a logout check provider module configured to determine whether the user should be logged out; an authorization token provider module configured to provide authorization tokens that provide for levels of authorization; and an authorizer module configured to determine whether the HTTP request is authorized, given the authenticated user identity and the authorization tokens.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of an embodiment of a system for integrated web application security framework.

FIG. 2 is a flow diagram of an embodiment of a method for integrated web application security framework.

FIG. 3 is a flow diagram of a session validation process according to an embodiment of a method for integrated web application security framework.

FIG. 4A is a first part of a flow diagram representing an authentication process according to an embodiment of a method for integrated web application security framework.

FIG. 4B is a second part of a flow diagram representing an authentication process according to an embodiment of a method for integrated web application security framework.

FIG. 5 is a flow diagram of an authorization process according to an embodiment of a method for integrated web application security framework.

FIG. 6 is a flow diagram of a process of associating rights to a user or a session according to an embodiment of a method for integrated web application security framework.

FIG. 7 is a block diagram illustrating a computing environment in which the techniques described for integrated web application security framework can be implemented, according to an embodiment of the invention.

### DETAILED DESCRIPTION

Embodiments of techniques for integrated web application security framework are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

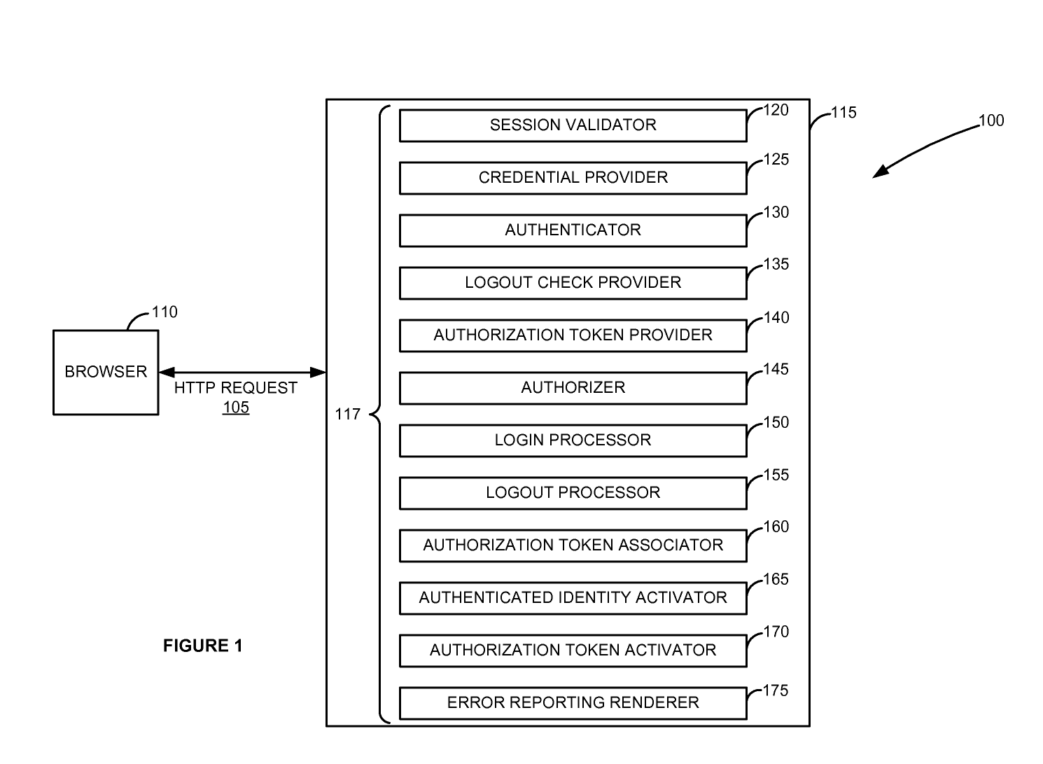

FIG. 1 is a block diagram of an embodiment of a system 100 for integrated web application security framework. A web server 115 receives an HTTP request 105 through a browser 110. Then in the web server 115, a set of modules 117 perform application security. A session validator 120 determines whether an existing session is invalidated. A session is a semi-permanent interactive information interchange, e.g. a session may store information associated with an individual user's interaction with the system. The session may be invalidated, for example, due to its expiry. A credential provider 125 provides credentials of a given kind. A credential may be a username-password combination, a SSO token, an OAuth token, or a SAML assertion. The credentials are extracted from the HTTP request 105. Then an authenticator 130 checks the credentials delivered by the credential provider 125 and produces an identity of a user. An identity of a user is produced if the provided credential is valid. Further, a logout check provider 135 determines whether the user should be logged out. This determination is based on the given HTTP request 105. Then an authorization token provider 140 provides tokens that imply certain levels of authorization. These levels of authorization may be, for example, capabilities given to the user. The levels of authorization are extracted from the HTTP request 105. Further, an authorizer 145 determines whether the HTTP request 105 is authorized, given the authenticated user identity and the collected authorization tokens. A login processor 150 and a logout processor 155 define a custom logic to be run before a user is logged in or logged out respectively. The login processor 150 performs actions necessary for setting up a logged-in user's interaction with the system, while logout processor 155 performs actions necessary for terminating a logged-in user's interaction with the system and removes temporary session state on disk and in a database associated with the user. In FIG. 1, an authorization token associator 160 associates the provided authorization tokens either with the session after login/logout or with the authenticated user. Further, an authenticated identity activator 165 associates the established user identity with a current thread, and an authorization token activator 170 associates the authorization tokens with the current thread. An error reporting renderer 175 renders an appropriate HTTP response in case of an error.

For the set of modules 117, there may be one, more than one, or no components of a type. The number of authenticators 130 depends on the types of credentials as extracted by an installed credential provider 125. Typically, there is exactly one authenticator 130 per type of credential extracted by a credential provider 125. In one embodiment, when there are no components of a specified type, the associated steps are skipped in the logic. For example, when there are no credential providers 125, no authenticators 130 are executed. Also, when there are one or more credential providers 125 but none of them extracted any credentials, no authenticators 130 are executed.

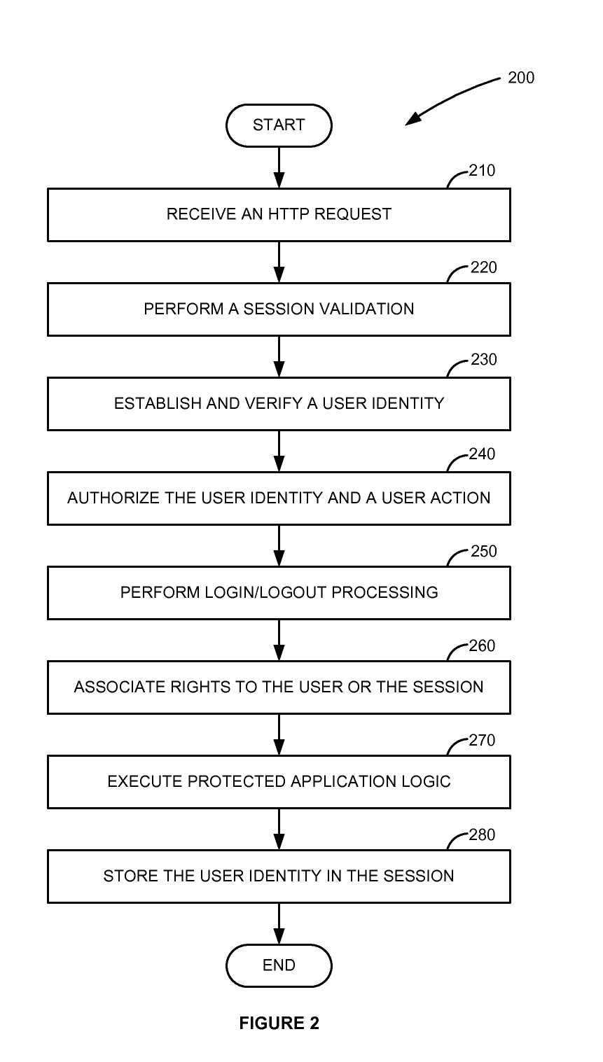

FIG. 2 is a flow diagram 200 of an embodiment of a method for integrated web application security framework. The method starts at block 210 with receiving an HTTP request. Then, at block 220, a session validation is performed. The session may be invalidated, for example, due to its expiry. At block 230, a user identity is established and verified. Then, at block 240, the user identity and a user action are fully authorized. Then, at block 250, login/logout processing is performed. The possible transitions between logged in and logged out states are given below in Table 1. Then, at block 260, rights are associated to the user or the session. Further, at block 270, the actual web application logic being protected by the integrated web application security framework is executed. Finally, at block 280, the user identity established at block 230 is stored in the session.

Table 1 is a table representing the possible state transitions between logged in and logged out states, and the associated actions taken according to an embodiment of a method for integrated web application security framework.

TABLE 1

| Start | Finish | Action |
|---|---|---|
| ε | A or B | Login |
| A | B | Logout-Login (atomic) |
| B | A | Logout-Login (atomic) |
| A or B | ε | Logout |
| ε | ε | Nothing |
| A | A | Nothing |

The used states are ε for NOBODY or anonymous identity, a first identity A, and a second identity B.

If the session started with NOBODY or an anonymous user (ε) but the authentication process establishes a new user identity that is not NOBODY nor an anonymous identity (A or B), login processing logic is performed. If the session started with a user identity that is not NOBODY nor an anonymous identity (A or B), and the authentication process established NOBODY or an anonymous identity (ε) as the user identity, logout processing logic is performed. If the session started with a user identity that is not NOBODY nor an anonymous identity (A), and the authentication process established a different user identity that is also not NOBODY nor an anonymous identity (B), and the ALLOW_ATOMIC_LOGOUT_LOGIN configuration flag is specified, logout processing is first performed, followed by login processing.

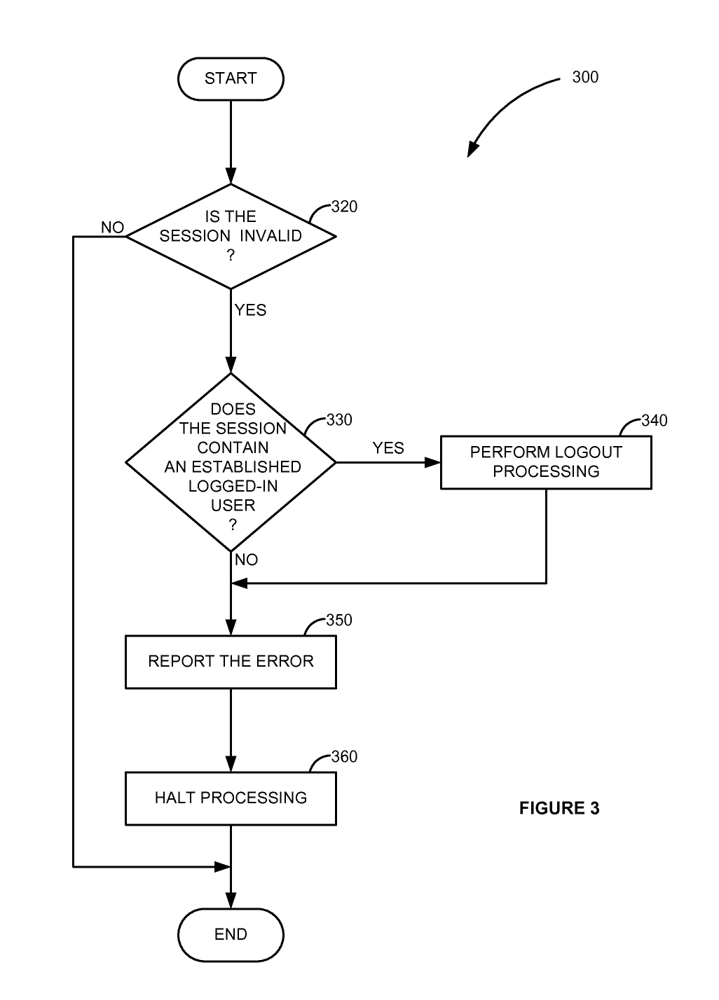

FIG. 3 is a flow diagram 300 of a session validation according to an embodiment of a method for integrated web application security framework. The method starts at block 320 determining whether the session is invalid. If the session is determined to be invalid at block 320, then, at decision block 330 a check is performed to determine if the session contains an established logged-in user. If an established logged-in user is present during the check at block 330, then logout processing is performed in block 340. After performing logout processing or if the check at decision block 330 establishes no logged-in user identity, then the error is reported in block 350 and process is halted in block 360.

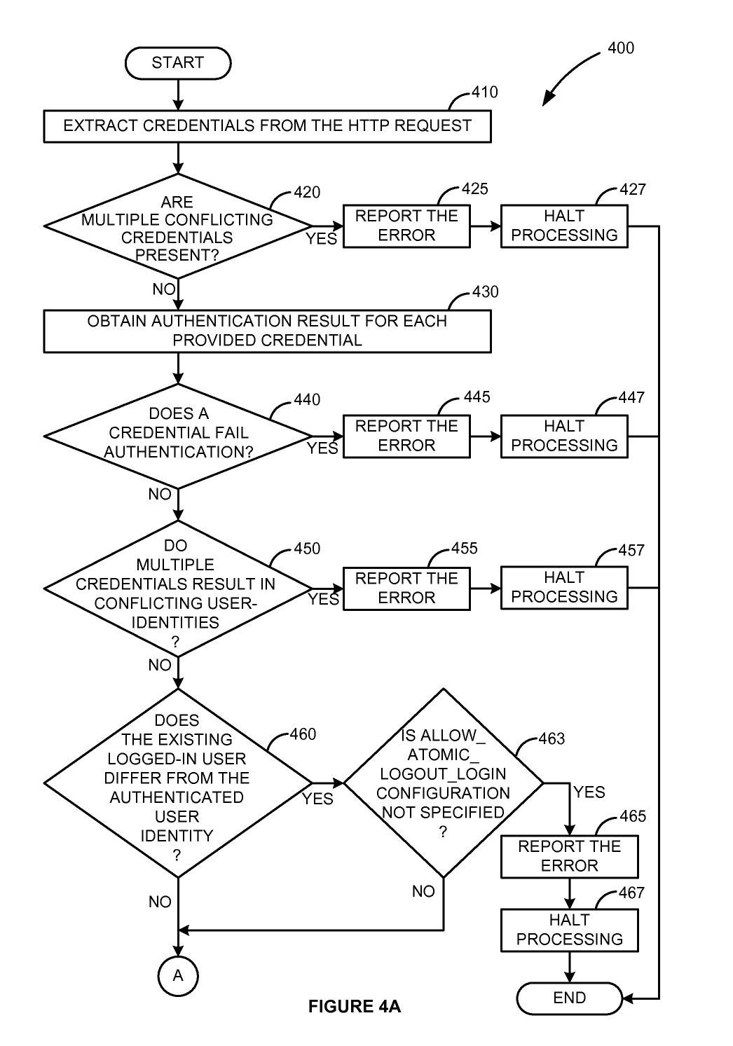

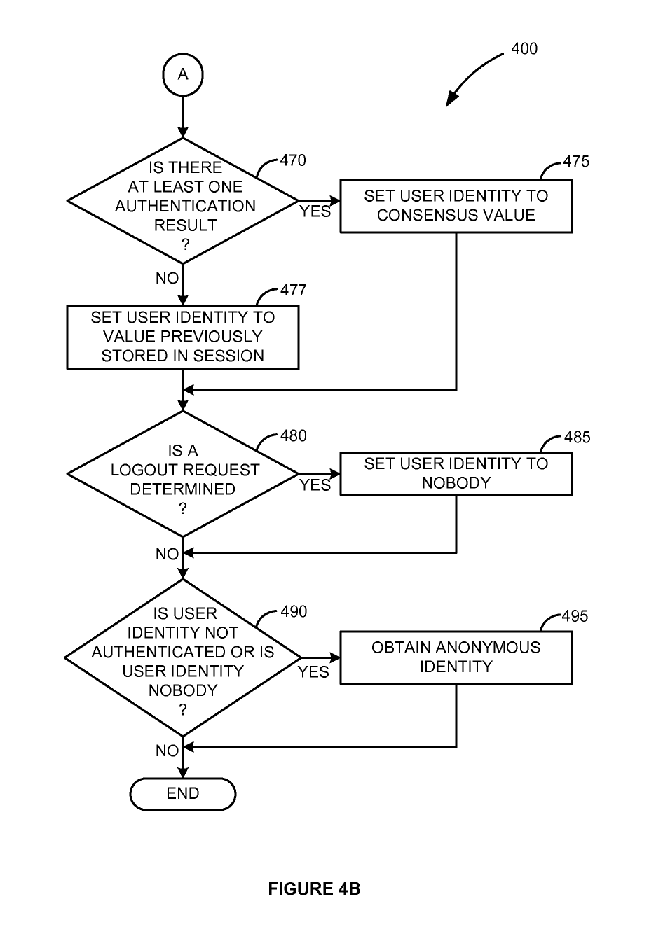

FIG. 4A and FIG. 4B represent a flow diagram 400 of an authentication process according to an embodiment of a method for integrated web application security framework. The authentication establishes and verifies a user identity. The process starts at block 410 with extracting credentials of a given kind from the HTTP request. A check is performed at decision block 420 to determine whether multiple conflicting credentials of the same type are present. If such conflicting credentials are determined at block 420, then the error is reported in block 425 and the process is halted at block 427. If no multiple conflicting credentials are determined at block 420, then the process continues at block 430 with obtaining authentication result for each provided credential. In various embodiments, processing at block 430 includes invoking one or more authenticators. The process continues with another check at block 440 if a credential fails authentication. In case a credential fails authentication at block 440, the error is reported in block 445 and the process is halted at block 447. If no credential fails at block 440, the process continues to decision block 450 to check if multiple credentials result in multiple conflicting user identities. Multiple conflicting user identities arise when two or more authenticators at block 430 differ and do not come to a consensus as to the authenticated identity. If such multiple credentials resulting in conflicting user credentials are determined at block 450, the error is reported at block 455 and the process is halted at block 457.

If no multiple credentials resulting in conflicting user credentials are present, the process continues to decision block 460, to check if the existing logged-in user associated with the session differs from the authenticated user identity. If the existing logged-in user associated with the session differs from the authenticated user identity, the process continues to decision block 463, to check if the ALLOW_ATOMIC_LOGOUT_LOGIN configuration flag is not specified. If the configuration flag is not specified, the error is reported at block 465 and the process is halted at block 467. If the configuration flag is specified at block 463, then the process continues at decision block 470 in FIG. 4B.

If, at decision block 460, the existing logged-in user associated with the session does not differ from the authenticated user identity, the process continues at decision block 470. At decision block 470, a check is performed to determine whether there are any authentication results. If there is at least one authentication result at block 470, the user identity is set to a consensus value at block 475 and the process continues to decision block 480. The consensus value may be the authentication identity agreed to by all of the authentication results that come after the block 450 or a special value representing NOBODY, e.g., the value of nil in the Ruby programming language. If there are no authentication results at block 470, at block 477 the user identity is set to the value previously stored in the session (i.e., the existing logged-in user associated with the session as compared against at decision block 460), and the process continues at decision block 480. At decision block 480, a check is performed for determined logout request. If at least one logout request is determined, then at block 485, the user identity is set to NOBODY and the process continues at decision block 490. If no logout request is determined at block 480, the process continues at decision block 490. At decision block 490, a check is performed to determine if the authentication results in a NOBODY identity or user identity is not authenticated. If such condition is determined at block 490, then at block 495 an anonymous identity is obtained and set as the user identity. An anonymous identity is a proxy with the same effective rights as the NOBODY identity.

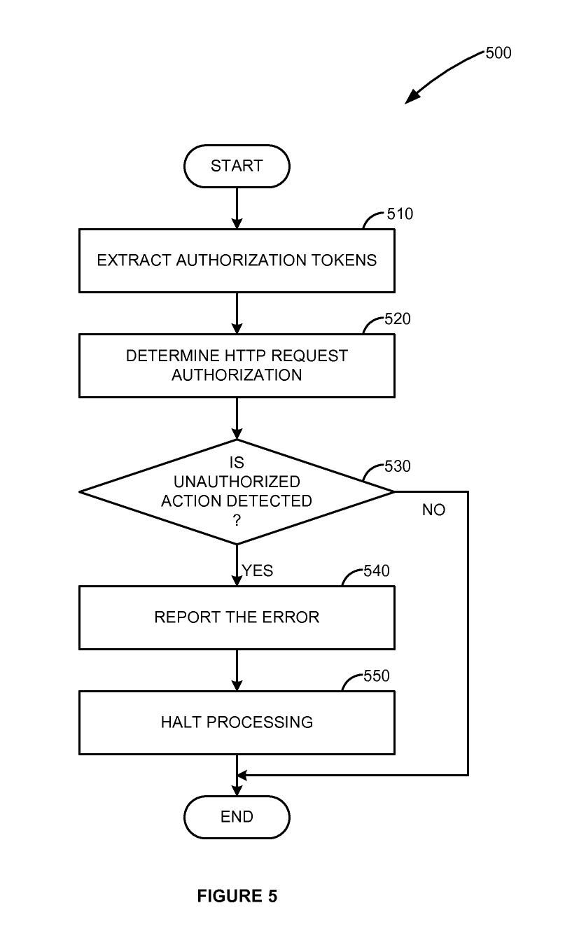

FIG. 5 is a flow diagram of an authorization process according to an embodiment of a method for integrated web application security framework. The process starts at block 510 with extracting authorization tokens that provide for levels of authorization, given an established user identity. Then, at block 520, it is determined whether the HTTP request is authorized, given the established user identity and the extracted authorization tokens. At decision block 530, it is determined whether an unauthorized action is detected. If at block 530 an authorized action is detected, an error is reported at block 540 and the process is halted at block 550. If no unauthorized action is detected at block 530, the process ends.

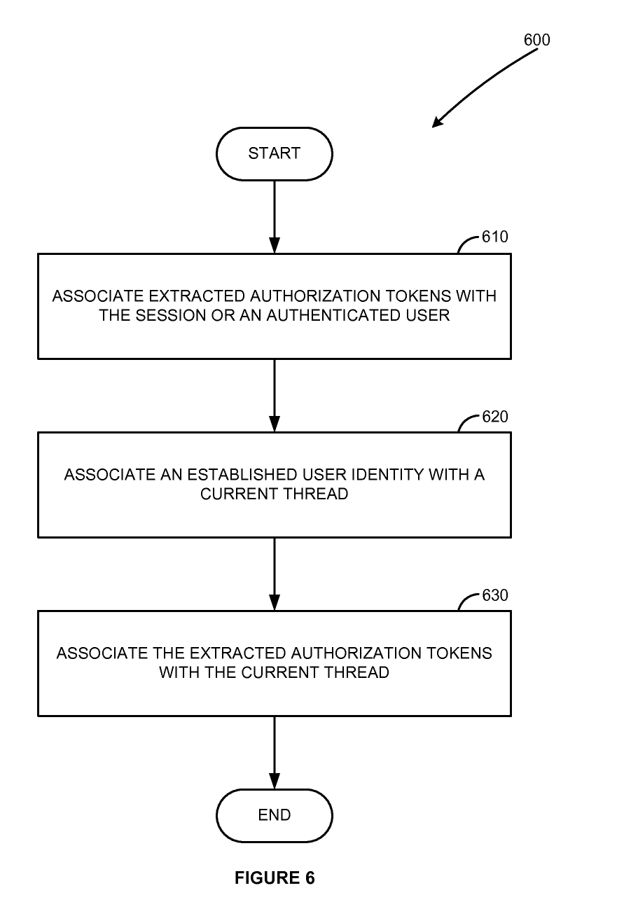

FIG. 6 is a flow diagram of a process of associating rights to a user or a session according to an embodiment of a method for integrated web application security framework. The process starts at block 610 by associating extracted authorization tokens with the session, after login/logout, or with an authenticated user. Then, at block 620, the process continues by associating an established user identity with a current thread. Further, at block 630, the extracted authorization tokens are associated with the current thread.

In one embodiment, the application security framework is installed globally at the root class of all controllers in the application. When the application follows Ruby on Rails convention, this root class would be the ApplicationController class. This in turn installs an around filter, which is capable of allowing or blocking the request from being processed and ensuring that unintentional changes to the session state are reverted after the request processing is finished. Once the framework is installed, callbacks can be registered for performing various actions. These callbacks can be registered at the root controller class level or at the individual subclass level. Callbacks, like filters, are passed on from parent class to child class. The kinds of callbacks that can be registered may be, for example, session validators, credential providers, authenticators, etc.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

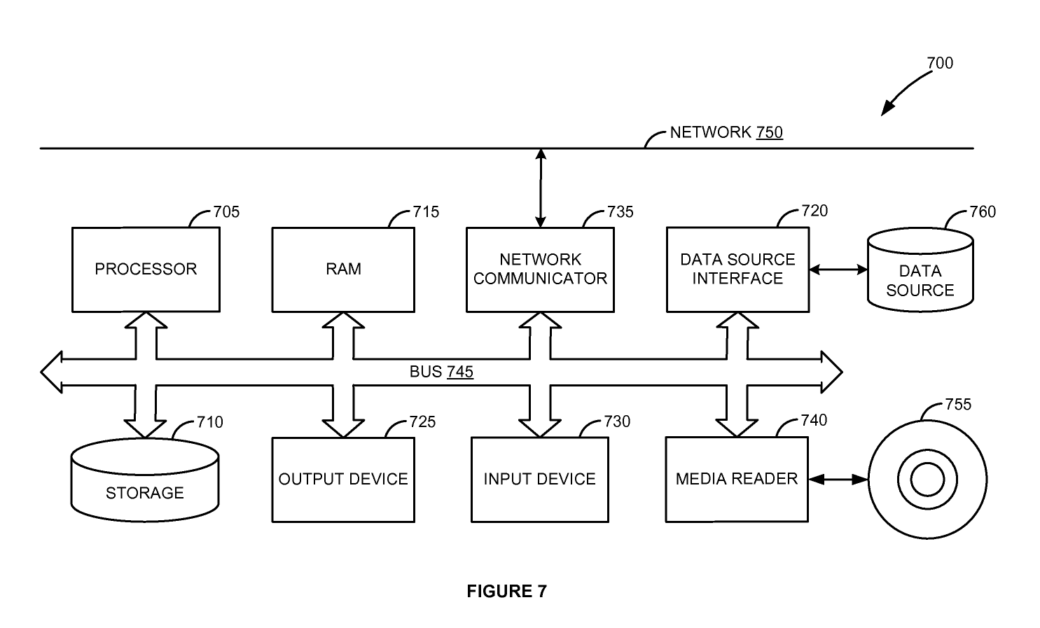

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to perform a method, the method comprising:
receiving an HTTP request;
performing validation of a session;
establishing and verifying a user identity;
authorizing the user identity and a user action;
performing login/logout processing; and
associating rights to a user or the session.

2. The article of manufacture of claim 1, wherein performing validation of the session further comprises:
determining session invalidation;
checking for an established logged in user in the session;
performing logout processing when a logged in user is established in the session; and
reporting an error and halting processing.

3. The article of manufacture of claim 1, wherein establishing and verifying the user identity further comprises:
extracting credentials from the HTTP request;
checking for multiple conflicting credentials;
reporting an error and halting processing when multiple conflicting credentials are determined;
obtaining an authentication result for each extracted credential;
reporting an error and halting processing when at least one of the credentials fails authentication; and
reporting an error and halting processing when multiple credentials result in multiple conflicting user identities.

4. The article of manufacture of claim 3, wherein establishing and verifying the user identity further comprises:
reporting an error and halting processing when the session indicates existing logged-in user different from one associated with an authenticated identity;
setting the user identity to a consensus value, when at least one authentication result is present;
setting the user identity to value previously stored in the session, when no authentication result is present;
determining a logout request;
setting the user identity to nobody when a logout request is determined;
determining whether the user identity is not authenticated or the user identity is nobody; and
obtaining an anonymous identity when the user identity is not authenticated.

5. The article of manufacture of claim 1, wherein authorizing the user identity and the user action further comprises:
extracting authorization tokens from the HTTP request that provide for levels of authorization, given an established user identity;
determining whether the HTTP request is authorized given the established user identity and the extracted authorization tokens;
determining an unauthorized action; and
reporting an error and halting processing when an unauthorized action is detected.

6. The article of manufacture of claim 1, wherein associating rights to the user or the session further comprises:
associating extracted authorization tokens with the session, after login/logout, or an authenticated user;
associating an established user identity with a current thread; and
associating the extracted authorization tokens with the current thread.

7. A computerized method for web application security, the method comprising:
receiving an HTTP request;
performing validation of a session;
establishing and verifying a user identity;
authorizing the user identity and a user action;
performing login/logout processing; and
associating rights to a user or the session.

8. The method of claim 7, wherein performing validation of the session further comprises:
determining session invalidation;
checking for an established logged in user in the session;
performing logout processing when a logged in user is established in the session; and
reporting an error and halting processing.

9. The method of claim 7, wherein establishing and verifying the user identity further comprises:
extracting credentials from the HTTP request;
checking for multiple conflicting credentials;
reporting an error and halting processing when multiple conflicting credentials are determined;
obtaining an authentication result for each extracted credential;
reporting an error and halting processing when at least one of the credentials fails authentication; and
reporting an error and halting processing when multiple credentials result in multiple conflicting user identities.

10. The method of claim 9, wherein establishing and verifying the user identity further comprises:
reporting an error and halting processing when the session indicates existing logged-in user different from one associated with an authenticated identity;
setting the user identity to a consensus value, when at least one authentication result is present;
setting the user identity to value previously stored in the session, when no authentication result is present;
determining a logout request;
setting the user identity to nobody when a logout request is determined;
determining whether the user identity is not authenticated or the user identity is nobody; and
obtaining an anonymous identity when the user identity is not authenticated.

11. The method of claim 7, wherein authorizing the user identity and the user action further comprises:
extracting authorization tokens from the HTTP request that provide for levels of authorization, given an established user identity;
determining whether the HTTP request is authorized given the established user identity and the extracted authorization tokens;
determining an unauthorized action; and
reporting an error and halting processing when an unauthorized action is detected.

12. The method of claim 7, wherein associating rights to the user or the session further comprises:
associating extracted authorization tokens with the user session, after login/logout, or an authenticated user;
associating an established user identity with a current thread; and
associating the extracted authorization tokens with the current thread.

13. A computer system for web application security including at least one processor and memory for executing program code, comprising:
a browser configured to send an HTTP request to a web server;
a set of modules associated with the web server, the set comprising:
a session validator module configured to determine whether an existing session is invalidated;
a credential provider module configured to provide credentials of a given kind, the credentials extracted from the HTTP request;
an authenticator module configured to verify provided credentials by the credential provider module and to produce an authenticated user identity for a user;
a logout check provider module configured to determine whether the user should be logged out;
an authorization token provider module configured to provide authorization tokens that provide for levels of authorization; and
an authorizer module configured to determine whether the HTTP request is authorized, given the authenticated user identity and the authorization tokens; and
a processor configured to execute the set of modules associated with the web server.

14. The system of claim 13, wherein the web server further comprises a login processor configured to run custom logic before and after a user is logged in.

15. The system of claim 13, wherein the web server further comprises a logout processor configured to run custom logic before and after a user is logged out.

16. The system of claim 13, wherein the web server further comprises an authorization token associator module configured to associate provided authorization tokens with the session after login/logout.

17. The system of claim 13, wherein the web server further comprises an authorization token associator module configured to associate provided authorization tokens with an authenticated user.

18. The system of claim 13, wherein the web server further comprises an authenticated identity activator module configured to associate an established user identity with a current thread.

19. The system of claim 13, wherein the web server further comprises an authorization token activator module configured to associate the authorization tokens with a current thread.

20. The system of claim 13, wherein the web server further comprises an error reporting renderer module configured to render an appropriate HTTP error response.
